(19) United States
(12) Patent Application Publication
(10) Pub. No.: US 2004/0190216 A1
(43) Pub. Date: Sep. 30, 2004

(54) Static dissipative housing for data cartridge carrying non-tape storage medium

(76) Inventors: Yung Yip, Afton, MN (US); Gregory A. Laska, Woodbury, MN (US); Jason D. Hanzlik, Wahpeton, ND (US); Leo W. Spychalla, Cottage Grove, MN (US)

Correspondence Address: Attention: Eric D. Levinson, Imation Corp., Legal Affairs, P.O. Box 64898, St. Paul, MN, 55164-0898, US

(21) Appl. No.: 10/822,884

(22) Filed: Apr. 13, 2004

Related U.S. Application Data
(63) Continuation-in-part of application No. 10/047,280, filed on Jan. 14, 2002.

(51) Int. Cl. G11B 15/68

(52) U.S. Cl. 361/234

(57) ABSTRACT

A data cartridge includes a housing having a surface resistivity in a range of approximately 10⁶ ohms/square to approximately 10¹² ohms/square, a non-tape storage medium contained within the housing, circuitry contained within the housing for accessing the non-tape storage medium, and an externally accessible electrical connector supported by the housing and electrically coupled to the circuitry.

### CROSS-REFERENCE TO RELATED APPLICATIONS

This application is a Continuation-in-Part of U.S. patent application Ser. No. 10/047,280, filed on Jan. 14, 2002, entitled “System Having Tape Drive Emulator and Data Cartridge Carrying a Non-Tape Storage Medium,” which is assigned to the assignee of the present invention and incorporated herein by reference.

### TECHNICAL FIELD

The present invention relates generally to data storage devices.

### BACKGROUND

Automated cartridge libraries provide access to vast amounts of electronic data by managing magnetic tape data cartridges. Automated cartridge libraries exist in all sizes, ranging from small library systems that may provide access to twenty or fewer data cartridges, to larger library systems that may provide access to thousands of data cartridges.

In a conventional automated cartridge library system, an automation unit, such as a robotic arm or other mechanism, typically services a plurality of data cartridge storage locations. The automation unit selectively retrieves a data cartridge from one of the storage locations and loads the retrieved data cartridge into a designated tape drive to access data stored by the data cartridge. Each data cartridge typically has some kind of identifying information, such as a label, a bar code, or a radio frequency (RF) tag, by which the automation unit identifies the individual data cartridges.

When the tape drive is finished with the data cartridge, the automation unit retrieves the data cartridge from the tape drive and returns it to the assigned data cartridge storage location. A host computing system communicates with a library control unit that typically controls the operation of the automated cartridge library. In this way, a large number of data cartridges are automatically accessible by one or more tape drives.

To manipulate a data cartridge, the automation unit typically has an interface that engages the data cartridge and allows the automation unit to convey and manipulate the orientation of the data cartridge. As a robotic arm, for example, the automation unit may include a gripper that grasps the selected data cartridge. Because the data cartridges must be positioned in a precise manner for the robotic arm to grasp them correctly, the data cartridges and the storage locations are constructed with exact dimensions. Accordingly, the data cartridges of the library system typically have substantially similar, if not identical, form factors to be received by the interface of the automation unit.

During handling and/or use of a data cartridge, static electricity may build up as a static charge within the cartridge. As such, the static charge of the cartridge may damage data stored in the cartridge and/or attract debris such as dust or other particles to the cartridge. In addition, when the data cartridge is moved into and/or out of a tape drive, the static charge may be imparted to the tape drive, thereby possibly damaging the tape drive.

Existing magnetic tape data cartridges have included housings formed of insulative materials which, unfortunately, retain static charges and conductive materials which discharge static charges, often at an extremely high voltage which itself may be damaging to the cartridge or the tape drive system. For example, one type of magnetic tape data cartridge such as a 3570-type data cartridge produced by Imation Corp. of Oakdale, Minn., includes a housing formed of a material which is conductive, such as a carbon-filled resin. During molding, however, conductivity of the material is affected thereby resulting in a varying surface resistivity throughout different areas of the housing.

Although conventional automated libraries provide access to vast amounts of information, conventional automated libraries using magnetic tape data cartridges do not allow for true random access of files stored within the data cartridges. In particular, a conventional magnetic tape data cartridge includes a length of magnetic storage tape wound around one or more wheels or hubs. As such, data may be read from or written to the magnetic storage tape by a magnetic read/write head of a tape drive system as the magnetic storage tape passes the magnetic read/write head. Thus, the tape drive typically writes data along a number of tracks that span the length of the magnetic storage tape.

For this reason, magnetic tape data cartridges can be viewed as sequentially storing data in a linear format. The linear data storage format of conventional magnetic tape data cartridges, however, prevents true random access of individual files. For example, the tape drive must scan through the entire length of the magnetic storage tape until the appropriate file mark and, therefore, corresponding data is identified, thereby increasing file retrieval time.

Due to the lack of true random access to individual files stored within magnetic tape data cartridges and the affinity for preexisting cartridge library systems, a need exists for a data cartridge configured to house and protect a non-tape storage device while being compatible with conventional automated data storage tape cartridge library systems.

### SUMMARY

One aspect of the present invention provides a data cartridge including a housing having a surface resistivity in a range of approximately 10⁶ ohms/square to approximately 10¹² ohms/square, a non-tape storage medium contained within the housing, circuitry contained within the housing for accessing the non-tape storage medium, and an externally accessible electrical connector supported by the housing and electrically coupled to the circuitry.

Another aspect of the present invention provides a data cartridge including a housing, a non-tape storage medium contained within the housing, means disposed within the housing for accessing the non-tape storage medium, an externally accessible electrical connector supported by the housing and electrically coupled to the means for accessing the non-tape storage medium, and means for dissipating a static charge in the data cartridge of approximately 5,000 volts DC to approximately 500 volts DC in less than approximately 0.5 seconds.

Another aspect of the present invention provides a data cartridge including a housing formed of a material including a static dissipative polymer and having a surface resistivity in a range of approximately 10⁶ ohms/square to approximately 10¹² ohms/square, a non-tape storage medium contained within the housing, circuitry for accessing the non-tape storage medium, and an externally accessible electrical connector electrically coupled to the circuitry.

### BRIEF DESCRIPTION OF DRAWINGS

FIG. 1 is a block diagram illustrating an example embodiment of an automated data cartridge library system.

FIG. 2 is a perspective view of an example embodiment of a data cartridge having a non-tape storage medium and selected for insertion into a tape drive emulator.

FIG. 3 is a block diagram illustrating an example embodiment of a tape drive emulator and a data cartridge having a non-tape storage medium.

FIG. 4 is a block diagram illustrating another example embodiment of a tape drive emulator and a data cartridge having a non-tape storage medium.

FIG. 5 is a block diagram illustrating another example embodiment of a data cartridge having a non-tape storage medium.

FIG. 6 includes a table outlining static decay and surface resistivity for housings of various data storage cartridges.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

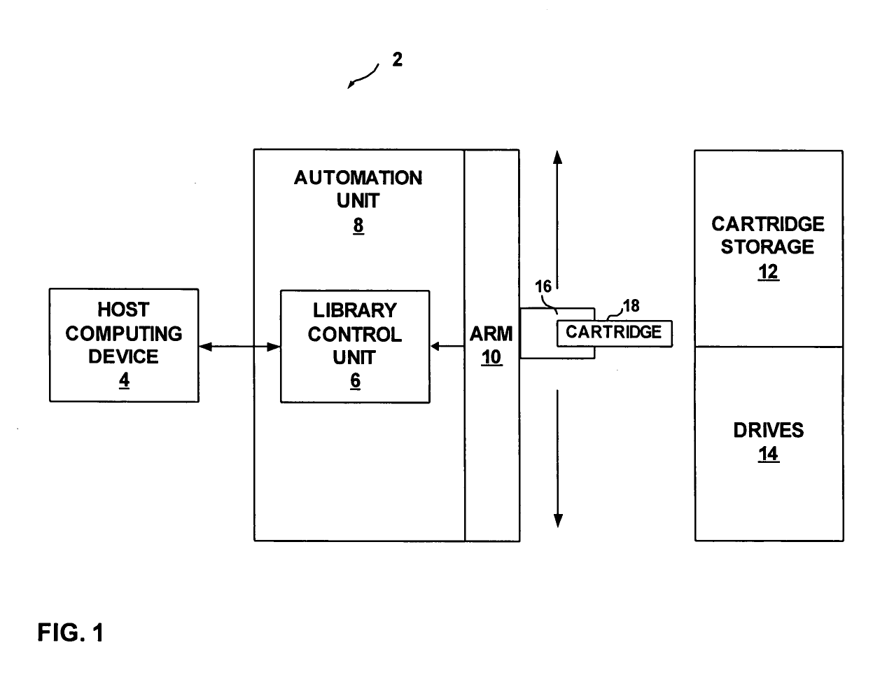

FIG. 1 is a block diagram illustrating an automated data cartridge library system 2. Automation unit 8 selectively retrieves a data cartridge 18 and loads the retrieved data cartridge 18 into one of drives 14. When the drive is finished with the data cartridge 18, automation unit 8 retrieves the data cartridge 18 from the drive and returns it to the assigned storage location within cartridge storage 12.

Accordingly, cartridge storage 12 provides a plurality of data cartridge storage locations. Each location, also referred to as a cell, provides storage for a single data cartridge. Each data cartridge typically includes a housing having standard dimensions and features to be easily engaged by automation unit 8. In addition, the data cartridges may have some type of identifying information, such as a label, a bar code, or a radio frequency (RF) tag, by which the automation unit 8 identifies the individual data cartridges.

A host computer 4 communicates with library control unit 6 to direct operation of data cartridge library system 2. In response to an access request from host computing device 4, library control unit 6 generates control signals to direct a robot arm 10 to retrieve the appropriate data cartridge from cartridge storage 12 and insert the data cartridge into one of drives 14. In particular, library control unit 6 interprets storage access requests from host computing device 4, and provides signals to control the motion and operation of robotic arm 10 and a gripper 16. In response to the signals, robotic arm 16 traverses cartridge storage 12 and engages a cartridge 18 using gripper 16. Upon insertion of data cartridge 18 into one of drives 14, host computing device 4 can write data to, and read data from, the data cartridge.

As described in detail herein, cartridge storage 12 may include a number of conventional data cartridges housing magnetic tape, as well as a number of data cartridges housing non-tape storage media. The non-tape storage media take the form of a variety of storage media, such as disk-shaped magnetic storage media, solid-state storage media, optical storage media, magneto-optical storage media, and holographic storage media.

Regardless of the type of internal storage media, the data cartridges have housings conforming to standard dimensions and features to be easily engaged by automation unit 8. Because the data cartridges conform to standard dimensions, cartridges housing different types of media are mechanically indistinguishable by automation unit 8. In this manner, the mechanical interfaces between automation unit 8 need not be adapted or upgraded to support non-tape media.

Furthermore, the data cartridges housing non-tape storage media may be self-contained storage devices that include necessary electronics and control circuitry for accessing the storage media. For example, a data cartridge may have standard external dimensions and features of a tape data cartridge, but may house a disk drive including the disk-shaped storage medium as well as the disk drive controller and read/write circuitry.

Accordingly, drives 14 may include one or more conventional tape drives and one or more tape drive emulators for receiving data cartridges housing non-tape storage media. In other words, drives 14 may include one or more tape drive emulators such that the non-tape storage media appear to host computing device 4 as sequential storage devices. Specifically, the tape drive emulators communicate with host computing device 4 as conventional tape drives. For example, in response to a query from host computing device 4, the tape drive emulators may identify themselves as conventional tape drives, such as a standard 3480 tape drive. Consequently, the drivers and other software applications executing on host computing device 4 for accessing tape-based data cartridges need not be modified.

As with the data cartridges carrying non-tape media, the tape drive emulators may be physically configured for use with conventional backup infrastructure, such as library system 2. For example, the tape drive emulators may conform to standard dimensions and form factors of conventional tape drives that may readily be inserted within a drive bay of library system 2. The tape drive emulators may, for example, have appropriately located power connectors, mounting holes and electrical sockets for receiving data cartridges carrying non-tape media.

In this manner, data cartridges housing non-tape storage media physically appear the same as magnetic tape data cartridges from the perspective of automation unit 10, and functionally appear the same from the perspective of host computing device 4. Accordingly, a wide variety of storage media may be used within library automation system 2 with little or no change to automation unit 10 or host computing device 4. Although described in reference to library system 2, the principles of the invention are not limited to automated data cartridge systems. A system administrator or other user may, for example, manually insert the data cartridges into drives 14.

In addition, library system 2 can easily be migrated to larger storage capacities without upgrading drives 14. Unlike conventional systems in which the drives must be upgraded to support larger capacity magnetic tape data cartridges, the tape drive emulators can readily support non-tape data cartridges having increased storage capacities. For example, the tape drive emulators may readily detect the storage capacity of inserted data cartridges having non-tape storage media, possibly by querying the data cartridges, and report the storage capacity to host computing device 4. In this manner, library system 2 can be viewed as forward compatible with ensuing data cartridges having increased storage capacity.

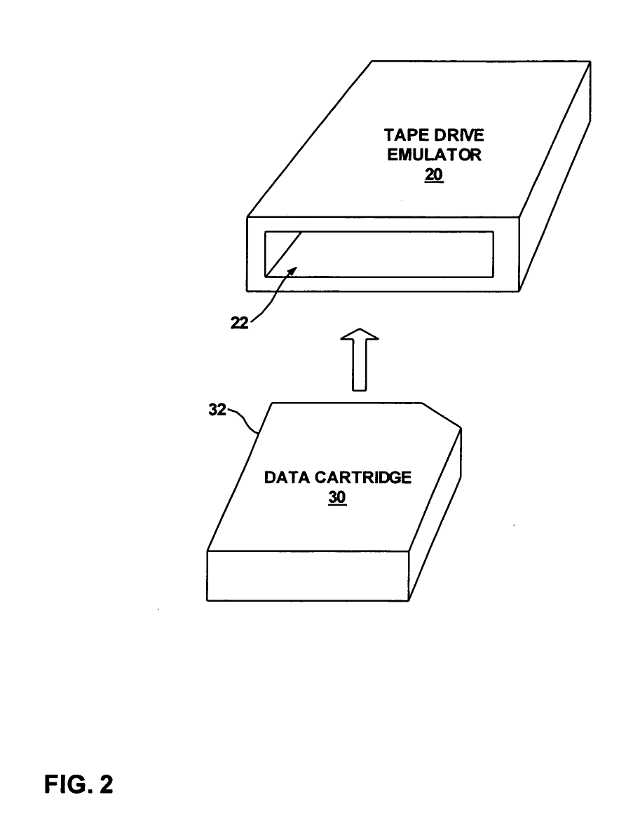

FIG. 2 is a perspective view of a tape drive emulator 20 and a data cartridge 30 selected from cartridge storage 12 (FIG. 1) for insertion into tape drive emulator 20 of drives 14. Data cartridge 30 contains a non-tape storage medium, and includes a housing 32 that conforms to standard external dimensions and features of magnetic tape data cartridges that may be used via system 2. For example, the external dimensions of data cartridge 30 may conform to one of a number of industry-standard form factors, such as the form factors of the Black Watch™ 9840 and Royal Guard™ 3480, 3490E, 3490EL and 9490EE magnetic storage tape cartridges manufactured by Imation Corp. of Oakdale, Minn. In one embodiment, as described in detail below, housing 32 is static dissipative.

Tape drive emulator 20 includes a socket 22 for receiving data cartridge 30. As illustrated below, unlike data cartridges used by system 2, socket 22 provides an electrical interface for accessing the non-tape storage medium contained with data cartridge 30. In particular, data cartridge 30 may house a fully self-contained non-tape storage device, including all necessary electronics and control circuitry for accessing the non-tape storage medium. For example, a data cartridge may house a disk drive including a disk-shaped storage medium as well as a disk drive controller, actuator, magnetic transducer, pre-amplifiers and read/write circuitry. Tape drive emulator 20 may have a form factor of a standard tape drive such that the location of socket 22 conforms to the location of a slot within the standard tape drive. In this manner, library system 2 may readily insert and remove data cartridge 30 without modification.

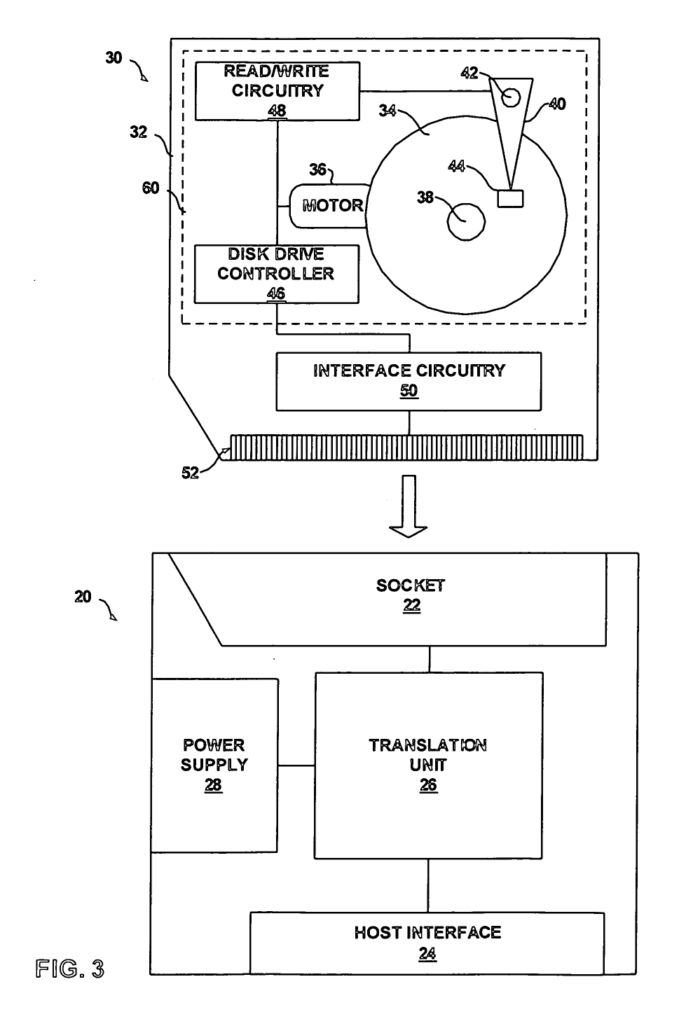

FIG. 3 is a block diagram illustrating example embodiments of tape drive emulator 20 and data cartridge 30 having a non-tape storage medium. Specifically, cartridge 30 includes housing 32 that forms an enclosure for disk storage medium 34 and various other components. Disk storage medium 34 may be any disk-shaped storage medium such as magnetic, optic, magneto-optic and the like. In addition, disk storage medium 34 may be a hard disk or flexible disk. Spindle motor 36 rotates disk storage medium 34 around spindle hub 38. Actuator 40 rotates around actuator shaft 42, causing transducer 44 to traverse the rotating disk storage medium 34 for reading and writing data.

Disk drive controller 46 controls read/write circuitry 48 and actuator 40 to output signals to, and senses signals from, transducer 44. Disk drive controller 46 communicates with emulator 20 via interface 50. Interface 50 may implement a non-conventional communications protocol, or may implement any standard interface protocol, such as the Small Computer System Interface (SCSI), the Fiber Channel interface, the Enhanced Integrated Drive Electronics/AT Attachment (EIDE/ATA) interface, or the like. In this manner, data cartridge 30 may comprise a fully self-contained disk drive 60, and may be purchased as an off-the-shelf component from one of a number of disk drive manufacturers, such as Seagate Technology of Scotts Valley, Calif.

Electrical connector 52 provides an externally available electrical interface for coupling to tape drive emulator 20 upon insertion by automation unit 8. In particular, electrical connector 52 provides input/output electrical pins for communicating with, and receiving power from, tape drive emulator 20.

Tape drive emulator 20 includes socket 22 to make a robust electrical connection to electrical connector 52 of data cartridge 30 upon insertion by automation unit 8. In one embodiment, socket 22 may comprise a zero insertion force (ZIF) socket. In particular, socket 22 may include a set of connectors operable to clamp and release electrical connector 52. Tape drive emulator 20 may, for example, mechanically actuate the connectors of socket 22 in response to sensing the insertion of the electrical connector of the data cartridge. Alternatively, gripper 16 may actuate a lever or other mechanical actuator of socket 22 to clamp down on and release the data cartridge 30. The layout of the mechanical connectors of socket 22 and the pins of connector 52 may take any one of a number of forms, such as array-shaped, staggered or inline.

Host interface 24 provides an electrical interface between tape drive emulator 20 and host computing device 4. Host interface 24 may conform to any one of a number of standard communications interfaces such as the Small Computer System Interface (SCSI), the Fiber Channel interface, the Network Data Management Protocol (NDMP), the Enhanced Integrated Drive Electronics /AT Attachment (EIDE/ATA) interface, or the like.

Tape drive emulator 20 may include a translation unit 26 for translating commands received from host interface 24 prior to delivering the commands to data cartridge 30 via socket 22. For example, translation unit 26 may receive data stream commands from host interface 24 that are typical for sequential access devices, such as tape drives, and may translate the stream commands into block commands that are more typical for disk drives or other storage devices. In addition, translation unit 26 may provide data buffering, compression and decompression, data reformatting, error detection and correction, and the like, in order to provide a tape drive interface to host computer 4 and a non-tape interface to the data cartridge 30. In this manner, tape drive emulator 20 allows a data cartridge carrying a non-tape storage medium to appear to host computing device 4 as a sequential storage device.

Furthermore, translation unit 26 allows host interface 24 and electrical connector 52 of data cartridge 30 to conform to different interface specifications. For example, translation unit 26 may support a SCSI interface between tape drive emulator 20 and host computer device 4, and an EIDE interface between tape drive emulator 20 and data cartridge 30. Translation unit 26 may comprise one or more custom application-specific integrated circuits. Alternatively, translation unit 26 could be implemented as a single board computer. Tape drive emulator 20 may also include a power supply 28.

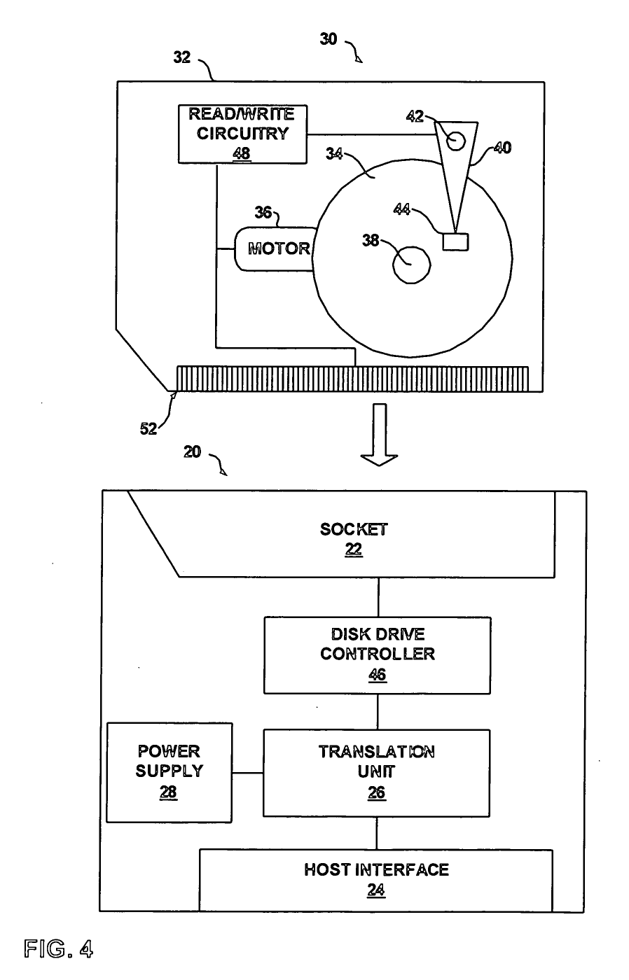

FIG. 4 is a block diagram illustrating another example embodiment of tape drive emulator 20 and data cartridge 30. In the illustrated embodiment, tape drive emulator 20 includes a portion of the drive electronics for accessing disk storage medium 34. Tape drive emulator 20 may include, for example, disk drive controller 46. As a result, data cartridge 30 may not need to include interface circuitry 50. In this manner, the cost and weight of data cartridge 30 may be reduced, which may be advantageous for high-volume applications. However, data cartridge 30 may no longer house a self-contained disk drive that can be purchased “off-the-shelf.” In either case, electrical connector 52 and socket 22 provide a robust electrical connection between tape drive emulator 20 and data cartridge 30 upon insertion by automation unit 8.

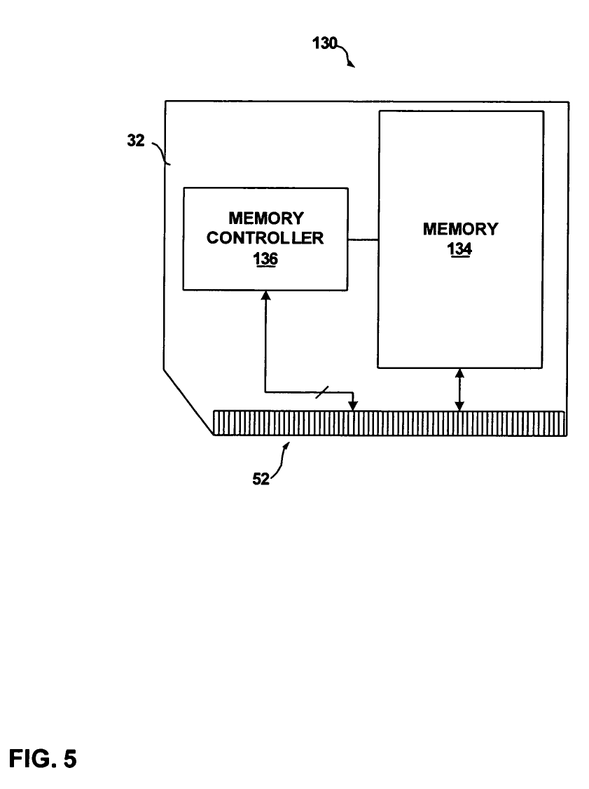

FIG. 5 is a block diagram illustrating another example embodiment of a data cartridge carrying a non-tape storage medium. Specifically, data cartridge 130 includes a solid-state memory 134 and a memory controller 136. Solid-state memory 134 may be any non-volatile memory such as an erasable programmable read only memory (EPROM), an electrically erasable programmable memory (FLASH memory), or the like. Memory controller 136 receives access requests from tape drive emulator 20 and performs address calculations to access storage locations within solid-state memory 134.

In this embodiment, translation unit 26 (FIG. 3) translates commands received from host interface 24 prior to delivering the commands to data cartridge 130 via socket 22. In particular, translation unit 26 translates the data stream commands from host interface 24 that are typical for tape drives into commands suitable for accessing one or more addressable storage cells within memory 134. In this manner, tape drive emulator 20 allows data cartridge 130 housing a solid-state storage medium to appear to host computing device 4 as a sequential storage device.

By making use of the present invention, an automated data cartridge system may include a number of conventional data cartridges housing magnetic tape, as well as a number of data cartridges housing non-tape media. Regardless of the type of internal storage media, the data cartridges have housings conforming to standard dimensions and features to be easily manipulated by the automation system. In this manner, the mechanical interfaces between the automation systems need not be adapted or upgraded to support data cartridges having non-tape media. In other words, because the data cartridges conform to standard dimensions, data cartridges housing different types of media can be mechanically indistinguishable by the automation system. Accordingly, the automated data cartridge system may readily include tape drives for accessing conventional magnetic tape data cartridges, and tape drive emulators for accessing data cartridges having non-tape media.

Furthermore, the data cartridges housing non-tape storage media may be self-contained storage devices that include necessary electronics and control circuitry for accessing the storage media. For example, a data cartridge may have standard external dimensions and features of a tape data cartridge, but may house a disk drive including the disk-shaped storage medium, as well as the disk drive controller and read/write circuitry.

In addition, the tape drive emulator receives a data cartridge carrying the non-tape storage medium and translates commands and performs other operations such that the data cartridge appears as a conventional sequential storage device to the host computing device. In this manner, the non-tape storage medium physically appears the same as a magnetic tape data cartridge from the perspective of the automation system, and functionally appears the same from the perspective of the host computing device.

The external electrical connector of the data cartridge and the socket of the tape drive provide a robust electrical connection between the tape drive emulator and the data cartridge. The use of a Zero Insertion Force (ZIF) socket may allow the automation unit to easily insert and remove the data cartridge from the tape drive emulator. Accordingly, a wide variety of storage media may be used within a library automation system with little or no change to the automation unit or the host computing device.

As described above, housing 32 of data cartridge 30 (including data cartridge 130) is static dissipative. In one embodiment, for example, housing 32 has a surface resistivity in a range of approximately 10⁶ ohms/square to approximately 10¹² ohms/square. Surface resistivity is a measurement of the resistance to flow of an electrical current over a surface. As a comparison, a surface resistivity greater than 10¹² ohms/square is considered insulative and a surface resistivity in a range of 10⁴ ohms/square to 10⁶ ohms/square is considered conductive. As such, a material which is insulative will retain a static charge and a material which is conductive will discharge a static charge, often at an extremely high voltage.

With housing 32 being static dissipative, however, dissipation of a static charge, often measured as static decay, can be controlled. For example, in one embodiment, housing 32 dissipates approximately 5000 volts DC to approximately 500 volts DC in less than approximately 0.5 seconds. In one embodiment, measurement of the static dissipation of housing 32 is performed under the procedures of National Fire Protection Association (NFPA) Standard 99 in accordance with Method 4046 of Federal Test Method Standard 101C. Such procedures include conditioning and testing at 50+/−2 percent relative humidity and 23+/−1 degrees Celsius with a limit of 0.5 seconds to 10 percent decay for a charge applied to a 3 inch ×5 inch ×⅛inch plaque of material.

In one embodiment, static dissipation of housing 32 is established by forming housing 32 of a thermal plastic material including a static dissipative polymer. More specifically, in one embodiment, housing 32 is formed of a material including at least one of polypropylene, polyethylene, polystyrene, nylon, polycarbonate, ABS, and acrylic, and a dissipative polymer. In one exemplary embodiment, housing 32 is formed of a material including polycarbonate, nylon, and a dissipative polymer. An example of such a material includes PermaState® 399X-10739A available from RTP Company of Winona, Minn. In another exemplary embodiment, housing 32 is formed of a material including ABS resin and a dissipative polymer. An example of such a material includes Stat-Loyo A BK8-115 available from LNP Engineering Plastics Inc. of Exton, Pa.

In another embodiment, static dissipation of housing 32 is established by forming housing 32 of a carbon-filled resin. More specifically, in one embodiment, housing 32 is formed of a material including at least one of ABS, polystyrene, polycarbonate, polypropylene, and nylon, and a carbon fiber or carbon powder. In one exemplary embodiment, housing 32 is formed of a material including polycarbonate and carbon powder. An example of such a material includes Stat-Kon® D-EP V-1 available from LNP Engineering Plastics Inc. of Exton, Pa.

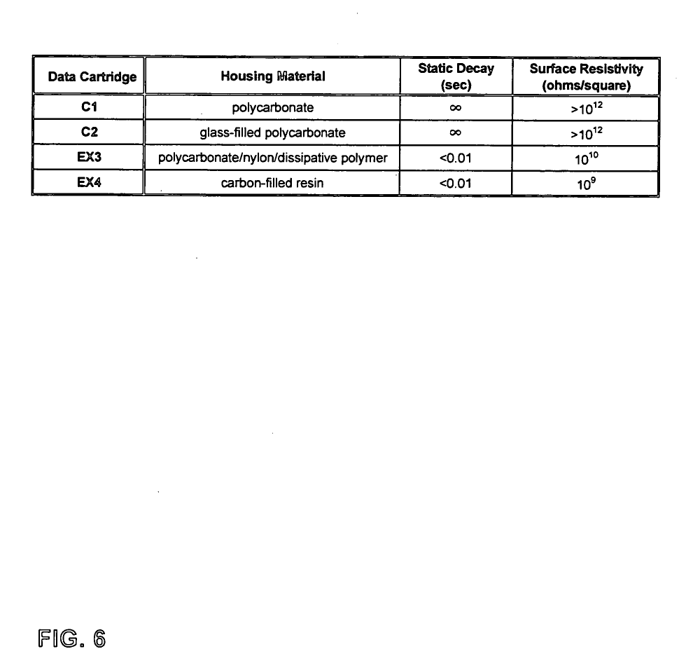

FIG. 6 includes a table outlining static decay and surface resistivity for housings of various data cartridges. In the table of FIG. 6, data cartridges C1 and C2 include comparative examples of data cartridges and data cartridges EX3 and EX4 include examples of data cartridges formed according to the present invention. For each of the data cartridges C1, C2, EX3, and EX4, static decay and surface resistivity of the respective housings is identified. In one embodiment, static decay is measured under the procedures of NFPA Standard 99 in accordance with Method 4046 of Federal Test Method Standard 101C, as described above.

The data cartridge of comparative example C1 includes a housing formed of a material including polycarbonate and the data cartridge of comparative example C2 includes a housing formed of a material including glass-filled polycarbonate. Static decay for comparative examples C1 and C2 is infinity in that the housings of comparative examples C1 and C2 do not dissipate an electrical charge. In addition, surface resistivity for comparative examples C1 and C2 is greater than 10¹² ohms/square. As such, the housings of comparative examples C1 and C2 are both insulative and retain static charges.

The data cartridge of example EX3, however, includes a housing formed of a material including polycarbonate, nylon, and a dissipative polymer. The static decay of example EX3 is less than approximately 0.01 seconds and the surface resistivity is approximately 10¹⁰ ohms/square. Thus, the housing of example EX3 is static dissipative. In addition, the data cartridge of example EX4 includes a housing formed of a material including carbon-filled resin. The static decay of example EX4 is less than approximately 0.01 seconds and the surface resistivity is approximately 10⁹ ohms/square. Thus, the housing of example EX4 is also static dissipative. Accordingly, the data cartridges of examples EX3 and EX4 effectively dissipate static charges in a controlled manner.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A data cartridge, comprising:
a housing having a surface resistivity in a range of approximately 10⁶ ohms/square to approximately 10¹² ohms/square;
a non-tape storage medium contained within the housing;
circuitry contained within the housing for accessing the non-tape storage medium; and
an externally accessible electrical connector supported by the housing and electrically coupled to the circuitry.

2. The data cartridge of claim 1, wherein the housing is adapted to dissipate approximately 5,000 volts DC to approximately 500 volts DC in less than approximately 0.5 seconds.

3. The data cartridge of claim 1, wherein the housing includes a static dissipative polymer.

4. The data cartridge of claim 1, wherein the housing is formed of a material including at least one of polypropylene, polyethylene, polystyrene, nylon, polycarbonate, ABS, and acrylic, and a dissipative polymer.

5. The data cartridge of claim 1, wherein the housing is formed of a material including a carbon-filled resin.

6. The data cartridge of claim 1, wherein the housing conforms to industry standard dimensions for a magnetic tape data cartridge.

7. The data cartridge of claim 1, wherein the non-tape storage medium comprises a disk-shaped storage medium.

8. The data cartridge of claim 1, wherein the non-tape storage medium comprises one of a solid-state storage medium, an optical storage medium, a magneto-optical storage medium, and a holographic storage medium.

9. A data cartridge, comprising:
a housing;
a non-tape storage medium contained within the housing;
means disposed within the housing for accessing the non-tape storage medium;
an externally accessible electrical connector supported by the housing and electrically coupled to the means for accessing the non-tape storage medium; and
means for dissipating a static charge in the data cartridge of approximately 5,000 volts DC to approximately 500 volts DC in less than approximately 0.5 seconds.

10. The data cartridge of claim 9, wherein means for dissipating the static charge includes the housing having a surface resistivity in a range of approximately 10⁶ ohms/square to approximately 10¹² ohms/square.

11. The data cartridge of claim 9, wherein means for dissipating the static charge includes the housing being formed of a static dissipative polymer.

12. The data cartridge of claim 9, wherein dissipating the static charge includes the housing being formed of a material including at least one of polypropylene, polyethylene, polystyrene, nylon, polycarbonate, ABS, and acrylic, and a dissipative polymer.

13. The data cartridge of claim 9, wherein means for dissipating the static charge includes the housing being formed of a material including a carbon-filled resin.

14. The data cartridge of claim 9, wherein the housing conforms to industry standard dimensions for a magnetic tape data cartridge.

15. The data cartridge of claim 9, wherein the non-tape storage medium comprises one of a solid-state storage medium, an optical storage medium, a magneto-optical storage medium, and a holographic storage medium.

16. A data cartridge, comprising:
a housing formed of a material including a static dissipative polymer and having a surface resistivity in a range of approximately 10⁶ ohms/square to approximately 10¹² ohms/square;
a non-tape storage medium contained within the housing;
circuitry for accessing the non-tape storage medium; and
an externally accessible electrical connector electrically coupled to the circuitry.

17. The data cartridge of claim 16, wherein the material of the housing further includes at least one of polypropylene, polyethylene, polystyrene, nylon, polycarbonate, ABS, and acrylic.

18. The data cartridge of claim 16, wherein the housing is adapted to dissipate approximately 5,000 volts DC to approximately 500 volts DC in less than approximately 0.5 seconds.

19. The data cartridge of claim 16, wherein the housing conforms to industry standard dimensions for a magnetic tape data cartridge.

20. The data cartridge of claim 16, wherein the non-tape storage medium comprises one of a solid-state storage medium, an optical storage medium, a magneto-optical storage medium, and a holographic storage medium.
